(19) United States
(12) Patent Application Publication
(10) Pub. No.: US 2015/0011267 A1
(43) Pub. Date: Jan. 8, 2015

(54) SECURING ACCESSORY ADAPTED TO MOBILE ELECTRONIC DEVICE

(71) Applicant: Techxar Corporation, San Mateo, CA (US)

(72) Inventor: John HUANG, San Mateo, CA (US)

(21) Appl. No.: 13/934,927

(22) Filed: Jul. 3, 2013

(51) Int. Cl. H04M 1/02; H04B 1/38

(52) U.S. Cl. CPC H04M 1/0202; H04B 1/3883
USPC 455/573; 455/575.1

(57) ABSTRACT

A securing accessory being adapted to a mobile electronic device is provided. The securing accessory includes a base pedestal and a supporting brace connected to the base pedestal. The supporting brace is attachable and detachable to the mobile electronic device and comprises a pair of arms which is able to grab onto the mobile electronic device and to provide frontal and/or lateral alignment for adequate securement. The pair of arms is spring-loaded for further providing mechanical force that compresses frontally and/or laterally to a direction of accessory insertion when mating the accessory with the mobile electronic device. By employing the pair of spring-loaded arms, the present invention is extraordinarily advantageous of being adapted to different mobile electronic devices having different thickness and meanwhile maintaining adequate securement and convenience in use while implementation.

### BACKGROUND OF THE INVENTION

1. Field of the Invention

The present invention relates to a securing accessory, and more particularly to a securing accessory being adapted to various mobile devices having different thickness.

2. Description of the Prior Art

Since the European Standardization Organizations CEN-CENELEC and ETSI harmonized the standards for the manufacturing of mobile phones compatible with a new common charger based on micro-USB connector and the widely adoption of Apple iDevices, there are now a plethora of accessories attachable to these mobile electronic devices in the market today for expanding their functionalities. These accessories may be a power bank, external camera flash, stereo speaker, FM receiver, etc. However, the means of securement of these accessories to the mobile device generally rely on the mechanical friction between the male and female end of the USB connectors, or in the case of Apple iDevices, the use of a small hook or detent on the connector of the accessory to mate with the iDevice. These methods generally provide less than adequate securement since they are more or less based on friction alone. Furthermore, in order to ensure proper detachment when the accessory is pulled away from the device as well, the attachment itself cannot be too tight. Therefore, in order to attach securely, alternate designs such as form-fitting accessories are shaped with the exact dimension of the intended mobile devices for mating. An example of there form-fitting accessories is a power bank that is shaped to mate with the mobile phone. The disadvantage of the form fitting accessories is the lack of universality of the accessory for attaching to other mobile devices that may be shaped differently, including the possibility of the user attaching a protective casing to the exterior of the mobile device.

On account of above, it should be obvious that there is indeed an urgent need for a novel accessory which can be adapted to different mobile devices both securely and conveniently. The accessory should be easily and quickly attached to and detached from the mobile device while ensuring securement when the accessory is attached, thereby, ensuring its convenience.

### SUMMARY OF THE INVENTION

In order to overcome the above-mentioned disadvantages, an approach in accordance with the present invention is provided for a novel accessory, which is adapted to securing different mobile electronic devices having different thickness. According to the present invention, the mobile electronic devices may be a mobile phone, a tablet PC or a personal digital assistant of various formats. The accessory itself may be a photo or video light product, a battery charger, or the like.

In one aspect, the securing accessory of the present invention comprises: a base pedestal and a supporting brace disposed on the base pedestal. The supporting brace is attachable and detachable to the mobile electronic device and comprises a pair of arms which grab onto the mobile electronic device and provide either frontal alignment or lateral alignment for adequate securement.

According to one embodiment of the present invention, the arms are spring-loaded for providing mechanical force that compresses frontally and/or laterally to a direction of accessory insertion when mating a connector.

According to one embodiment of the present invention, the arms are actuated by fingers of a same hand holding the accessory, permitting one hand operation for disengaging the spring-loaded arms when attaching or detaching the accessory.

According to another embodiment of the present invention, the arms are curved, thereby permitting a user forcing insertion to open up the arms without even pressing with hand to open up.

The base pedestal may further comprise a lithium battery inside for charging the mobile electronic device. And a micro universal serial bus (USB) may be optionally connected to an external power source or power bank for charging the lithium battery. An indicating unit, for example, a lighting device disposed on the supporting brace, can also be configured to show radiation when the lithium battery is charged so as to remind the users.

Furthermore, in order to meet the safety regulation, a heat sink can be utilized to dissipate heat generated by the lithium battery, the lighting device or the mobile electronic device.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 shows a front view of a securing accessory in accordance with one embodiment of the present invention.

FIG. 2 shows a back view of a securing accessory in accordance with one embodiment of the present invention.

FIG. 3 shows a schematic view of a securing accessory being attached to an iPhone in accordance with one embodiment of the present invention.

FIG. 4 shows a schematic view of a securing accessory being attached to an iPhone with protective case as the arms are tightened in accordance with one embodiment of the present invention.

FIG. 5 shows a schematic view of a securing accessory being attached to an iPhone for taking photo or video in any position in accordance with one embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

The embodiments described below are illustrated to demonstrate the technical contents and characteristics of the present invention and to enable the persons skilled in the art to understand, make, and use the present invention. However, it shall be noticed that, it is not intended to limit the scope of the present invention. Therefore, any equivalent modification or variation according to the spirit of the present invention is to be also included within the scope of the present invention.

In order to achieve the purpose of excellent securement when the accessory is attached, thereby, ensuring its convenience, the proposed structure of the present invention provides a securing accessory, which incorporates a pair of arms which are configured to grab onto a mobile electronic device the securing accessory itself is attached to such that the arms can provide either frontal alignment or lateral alignment, and meanwhile maintaining excellent and adequate securement.

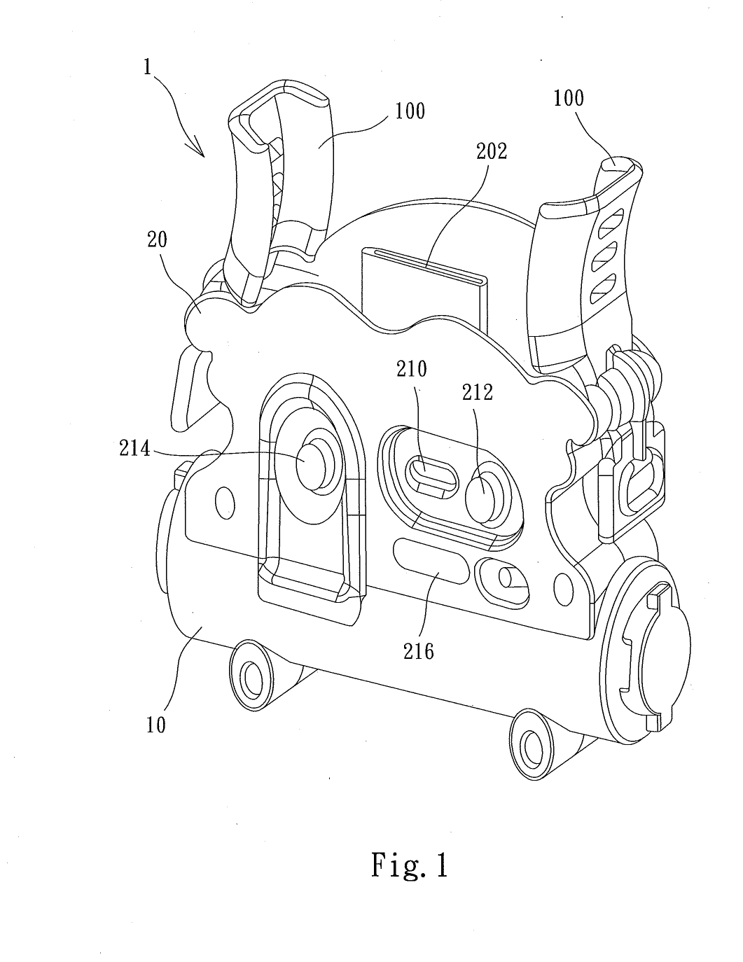

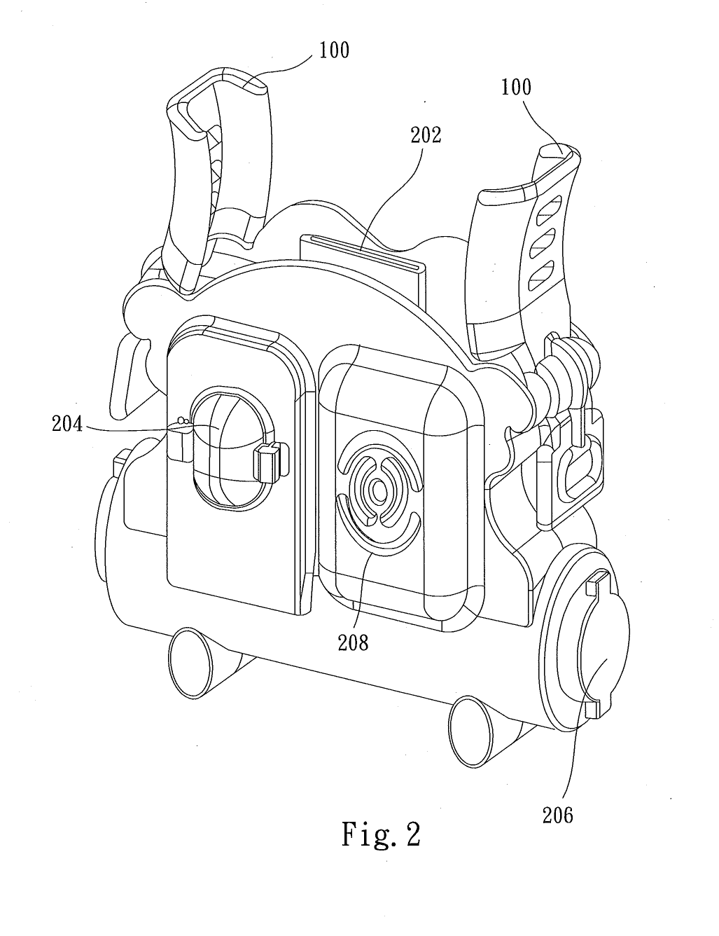

Refer to FIG. 1 and FIG. 2, which respectively shows a front view and a back view of a securing accessory in accordance with one embodiment of the present invention.

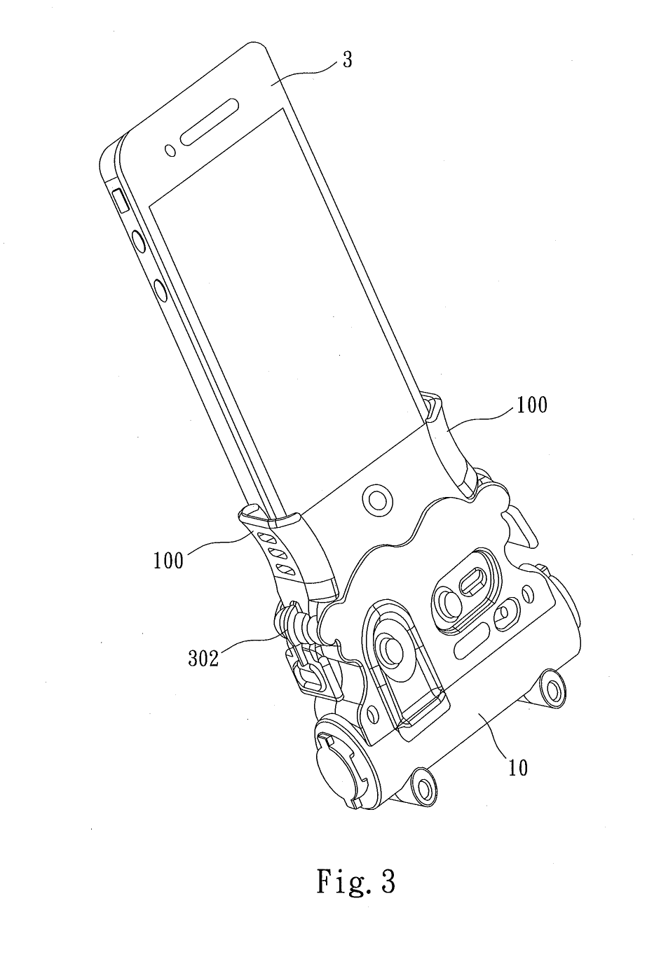

According to the present invention, the securing accessory 1 includes a base pedestal 10 and a supporting brace 20 which is disposed on the base pedestal 10. A pair of arms 100 is arranged on the supporting brace 20 for grabbing onto a mobile electronic device such that it provides frontal alignment and/or lateral alignment when mating the accessory 1 to the mobile electronic device. In one embodiment, the mobile electronic device is a mobile phone such as iPhone. In other embodiments, the mobile electronic device may also be a tablet PC or a personal digital assistant of various formats. The explanatory schematic (FIG. 3) is a drawing which shows the accessory of the present invention being securely attached to an iPhone. However, it is not intended to limit the scope of the present invention. Any equivalent modification or variation, i.e. replacing the iPhone with other mobile phones of different brands or replacing the iPhone with other tablet PC or personal digital assistant according to the spirit of the present invention is to be also included within the scope of the present invention.

According to the embodiment of the present invention, as shown in FIG. 1 to FIG. 3, the supporting brace 20 further comprises a connector 202 in which the accessory 1 is attached to the mobile electronic device 3 via the connector 202. Therefore, the registration in both a lateral plane and a median plane of the mobile electronic device 3 to the accessory 1 is implemented by employing the arms 100 along with the connector 202, which not only center the electrical connection between the mobile electronic device 3 and the accessory 1 but to secure them together as well.

To be more specific, the pair of arms 100 is equipped with spring 302 such that the arms 100 are spring loaded. These spring-loaded arms 100 provide a mechanical force that compresses laterally and/or frontally to the direction of accessory insertion when mating the connector 202, therefore, ensuring an excellent securement of the accessory 1 to the mobile electronic device 3. In other words, the design of the grab arms can provide both the frontal and lateral compression, which ensures the stabilization and orientation of the mobile electronic device 3 as it self-aligns with the accessory 1.

According to one embodiment of the present invention, when in application, the grab arms can be actuated by user's fingers of the same hand holding the accessory 1 so as to permit one hand operation for disengaging the spring-loaded arms 100 when attaching or detaching the accessory 1 itself since the arms 100 will ensure the connector 202 is lined up between the mobile electronic device 3 and the accessory 1 as the arms 100 are compressed together. As a result, the user can operate with just one hand and is able to mate the connector without other elaborate steps.

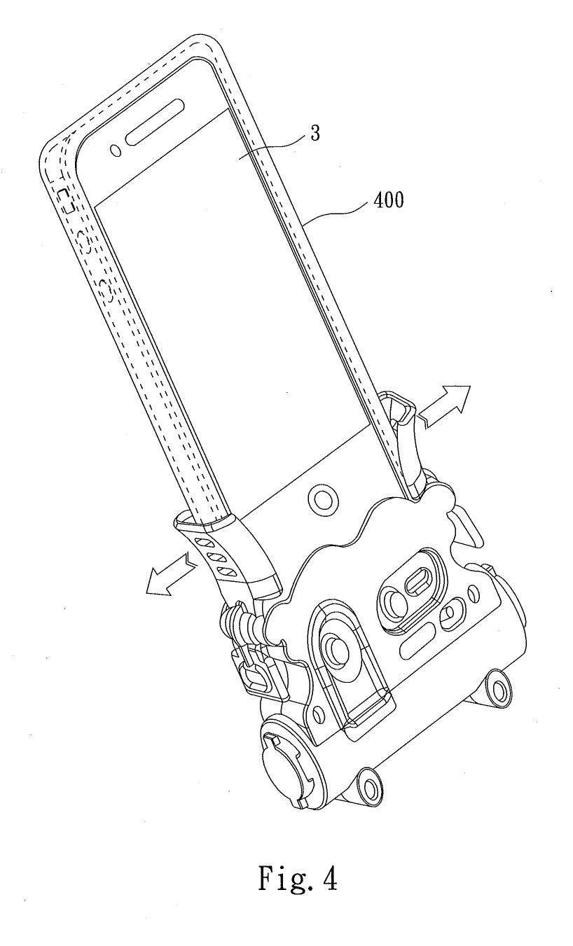

According to another embodiment of the present invention, the grab arms 100 may alternatively be designed to have curve shape. Under such circumstances, when the arms 100 are curved, the user can force insertion to open up the arms 100 even without pressing with hand to open up, thereby effectively increasing the convenience in use of the present invention. Furthermore, since the curve arms 100 can center the mobile electronic device 3 as it is inserted into the accessory 1 by forcing frontal alignment and lateral alignment, it allows the accessory 1 to be able to adapt to different mobile electronic devices, such as iPhone and iPod, and different versions of iPhone and iPod. Also, it can be adaptable to the mobile electronic device 3 with or even without external rubber case or any type of protective cover 400 that would increase the frontal and lateral thickness as shown in FIG. 4.

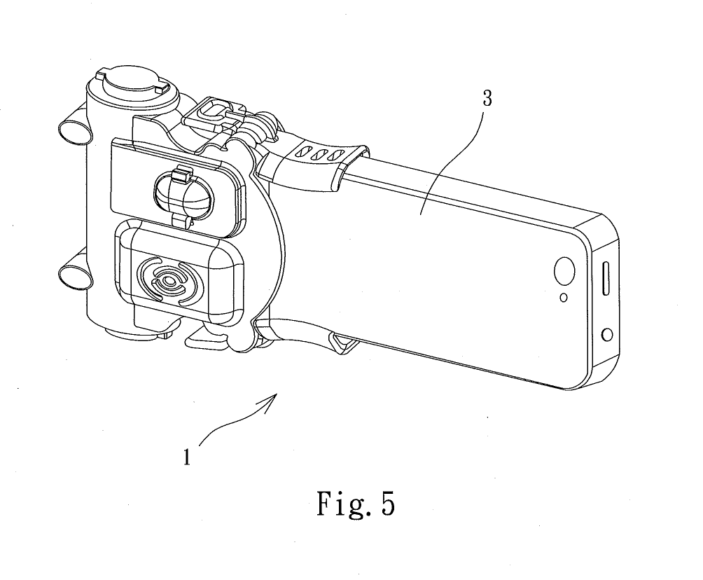

According to the embodiment of the present invention, please refer to FIG. 1 and FIG. 2. The supporting brace 20 may further comprises a lighting device 204, for example, a light-emitting-diode (LED) for increasing luminance when the mobile electronic device 3 is photo-shot or video-shot in darkness. In such an embodiment, the accessory 1 of the present invention is a photo or video light product. FIG. 5 is a drawing which shows the accessory of the present invention being securely attached to an iPhone for taking photo or video in any position. As shown in FIG. 5, it is obvious that the accessory 1 of the present invention provides universality of position in-use and meanwhile guarantees adequate securement to the mobile electronic device it is applied to. In other embodiment of the present invention, the accessory may also be a battery charger.

Apart from above, a lithium battery 206 can be optionally disposed inside the base pedestal 10 of the accessory 1 for charging the lighting device 204 and/or the mobile electronic device 3. A heat sink 208 is configured to dissipate the heat generated by the lithium battery 206, the lighting device 204 and/or the mobile electronic device 3. A micro universal serial bus (USB) port 210 can be disposed on the supporting brace for connecting to a power source to charge the lithium battery 206. In one embodiment, the power source may be a power bank, a direct current source, or an alternate current source. Moreover, a first button 212 and a second button 214 can be disposed on the supporting brace for controlling when the lithium battery 206 starts to charge, and for turning on or off the lighting device 204, respectively. For example, the lithium battery 206 will start to charge when the user presses the first button 212, and the lighting device 204 is turned on or off when the user presses the second button 214. Furthermore, an indicating unit 216 can be further configured on the supporting brace 20 for showing radiation when the lithium battery 206 is charged so as to remind the user. According to an embodiment of the present invention, the indicating unit 216 for example can be an LED, a zener diode, or the like. Certainly, other simple combinations of the above-mentioned elements can optionally be implemented to meet different manufacturing specifications. The proposed invention is fully described abovementioned but not limited thereto.

As a result, to sum up, a novel securing accessory has been provided in the present invention for being adapted to different mobile electronic device and for maintaining extraordinary securement and convenience when the accessory is attached. By using a pair of spring-loaded arms, a user is allowed to operate with one hand when attaching or detaching the accessory. Moreover, the user may further open up the arms even without pressing with hand to open up when the arms are configured to be curved. Since the arms provide frontal alignment and/or lateral alignment when mating with the mobile electronic device, the novel accessory of the present invention can be securely attached to the mobile electronic device in any position, thereby having high and unlimited potential in the markets nowadays.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A securing accessory adapted to a mobile electronic device, comprising:
a base pedestal; and
a supporting brace disposed on said base pedestal, wherein said supporting brace is attachable and detachable to said mobile electronic device and comprises a pair of arms which grab onto said mobile electronic device and provide either frontal alignment or lateral alignment for adequate securement.

2. The securing accessory adapted to a mobile electronic device of claim 1, wherein said supporting brace further comprises a connector and said accessory is attached to said mobile electronic device via said connector.

3. The securing accessory adapted to a mobile electronic device of claim 2, wherein said arms are spring-loaded for providing mechanical force that compresses frontally and laterally to a direction of accessory insertion when mating said connector.

4. The securing accessory adapted to a mobile electronic device of claim 3, wherein said arms are actuated by fingers of a same hand holding said accessory, permitting one hand operation for disengaging said spring-loaded arms when attaching or detaching said accessory.

5. The securing accessory adapted to a mobile electronic device of claim 3, wherein said arms are curved, thereby permitting at least one user forcing insertion to open up said arms without pressing with hand to open up.

6. The securing accessory adapted to a mobile electronic device of claim 1, wherein said supporting brace further comprises a lighting device for increasing luminance when said mobile electronic device is photo-shot or video-shot in darkness.

7. The securing accessory adapted to a mobile electronic device of claim 6, wherein said lighting device is a light-emitting-diode (LED).

8. The securing accessory adapted to a mobile electronic device of claim 1, wherein said accessory is a battery charger.

9. The securing accessory adapted to a mobile electronic device of claim 6, wherein said base pedestal further comprises a lithium battery inside for charging said lighting device or said mobile electronic device.

10. The securing accessory adapted to a mobile electronic device of claim 9, further comprising a micro universal serial bus (USB) port being connected to a power source for charging said lithium battery.

11. The securing accessory adapted to a mobile electronic device of claim 10, further comprising an indicating unit disposed on said supporting brace, wherein said indicating unit shows radiation when said lithium battery is charged.

12. The securing accessory adapted to a mobile electronic device of claim 9, further comprising a heat sink for dissipating heat generated by said lithium battery, said lighting device or said mobile electronic device.

13. The securing accessory adapted to a mobile electronic device of claim 9, further comprising a first button for controlling when said lithium battery starts to charge.

14. The securing accessory adapted to a mobile electronic device of claim 6, further comprising a second button for turning on or turning off said lighting device.

15. The securing accessory adapted to a mobile electronic device of claim 1, wherein said mobile electronic device is a mobile phone, tablet PC or personal digital assistant.
